(19) United States
(12) Patent Application Publication
(10) Pub. No.: US 2005/0027046 A1
(43) Pub. Date: Feb. 3, 2005

(54) Recycled tire rubber emulsions and processes for making them

(76) Inventor: John Eric Partanen, Bakersfield, CA (US)

Correspondence Address: James M. Duncan;Klein, DeNatale, Goldner, Cooper, Rosenlieb &, Kimball, LLP, P.O. Box 11172, Bakersfield, CA, 93389-1172, US

(21) Appl. No.: 10/808,960

(22) Filed: Mar. 24, 2004

Related U.S. Application Data
(60) Provisional application No. 60/491,136, filed on Jul. 30, 2003.

(51) Int. Cl. C08K 3/20

(52) U.S. Cl. 524/59

(57) ABSTRACT

Petroleum asphalt emulsions which contain recycled tire rubber and processes for making the emulsions at temperatures above ambient or room temperature. These emulsions may contain significant quantities of recycled tire rubber and recycled and reclaimed motor oils and fluxes. All of these formulations meet current specifications for products used to make slurry seal asphalt pavement coatings, ASTM D 1227 emulsified asphalt roof coatings, and may have applications as crackfillers for asphalt and portland cement pavements, and as parking lot seal-coat materials.

Cross-Reference To Related Application: U.S. Provisional Application No. 60/491136 was filed for this invention on Jul. 30, 2003 for which the inventor claims domestic priority.

### BACKGROUND OF THE INVENTION

This invention relates to improved petroleum asphalt emulsions and to processes for making these improved emulsions. These improved emulsions are mixtures of ingredients comprising petroleum asphalt and granulated recycled tire rubber. In addition, the improved emulsions may also comprise tall oil pitch, petroleum base lube oils and lube oil extracts, reclaimed and recycled motor oil fluxes, water, surfactants, clays and clay-like materials, chemicals, and mineral aggregates.

The inventor herein has had in effect U.S. Pat. No. 4,437,896 issued Mar. 20, 1984 (the '896 patent). In the '896 patent are formulations and processes for making various synthetic asphalt compositions including synthetic asphalt emulsions. The present invention comprises improvements to petroleum asphalt emulsions and processes for making the emulsions. These emulsions are formulated at elevated temperatures, more specifically at temperatures from 130 to 210 degrees Fahrenheit.

Petroleum asphalt is typically made of petroleum products, and includes two components:

(1) asphaltenes, or petroleum resins, and (2) maltenes, or heavy oils. The asphaltenes are generally dispersed and melted in the maltenes or heavy oils. There are two primary factors in the manufacture of petroleum asphalts which generally determine the grade of the asphalts. They are the proportion of asphaltenes to the maltenes and the viscosity of the maltenes.

The cost of petroleum asphalt, and petroleum base asphalt recycling agents, has risen sharply in the past few years. Current costs cause the repair of existing asphalt roadways and the construction of new asphalt roadways to be relatively expensive. It is likely that such costs will continue to rise. Recycled tire rubber may be used as a component of petroleum asphalt emulsions, thus reducing the cost of these materials. Emulsions of asphalt mixtures may incorporate recycled tire rubber products and residue into products which may be used to construct, repair, and maintain city streets, county roads, and state and Interstate highways. In addition, some of these products may be formulated to be used as roofing materials and coatings for industrial and commercial buildings. The processes described herein include the production of asphalt emulsions containing recycled tire rubber at above ambient temperatures.

Prior attempts to formulate asphalt emulsions containing recycled tire rubber have been unsuccessful because: (1) The granulated recycled tire rubber had a tendency to not stay in suspension after being added to the asphalt emulsion; (2) adding granulated recycled tire rubber to asphalt emulsions sometimes ruins the asphalt emulsion; (3) adding the tire rubber to the asphalt prior to making the emulsion makes the tire rubber modified petroleum asphalt extremely difficult to emulsify; and (4) most emulsions made from tire rubber modified petroleum asphalt do not store well, making them difficult to use. The disclosed emulsions overcome these difficulties.

### SUMMARY OF THE INVENTION

The following five examples disclose petroleum asphalt/clay-in-water emulsions that contain recycled tire rubber. Also disclosed are processes for making the emulsions at temperatures above ambient or room temperature. While, depending upon the application, some of these formulations may provide superior results to other formulations, all meet current specifications for products used to make slurry seal asphalt pavement coatings, ASTM D 1227 emulsified asphalt roof coatings, and may have applications as crackfillers for asphalt and portland cement pavements, and as parking lot seal-coat materials. Of particular interest is the use of significant quantities of recycled tire rubber and recycled and reclaimed motor oils and fluxes in these formulas and processes.

Aluminum chloride and ferric chloride may be used in the clay-in-water solutions as co-emulsifiers. Aluminum chloride, in solution, yields both positive aluminum ions and negative chloride ions. The aluminum ions attach to the clay particles and render them capable of emulsifying the asphalt base. The chloride ions lower the pH of the clay-in-water solution to below 6.5, which is required to make a stable mineral colloidal emulsion. Similarly, ferric chloride, in solution, yields both positive ferric ions and negative chloride ions. Chemists skilled in the art of making bentonite clay mineral colloidal emulsions usually use chromium ions with clays to render them as emulsifying agents. In recent years however, the use of chromium has been found to be harmful, toxic, and hazardous. Aluminum and ferric ions react chemically in many similar ways to chromium, but do not share the unhealthy and harmful effects of chromium.

### DETAILED DESCRIPTION OF THE INVENTION AND PROCESSES

A. Asphalt-Tire Rubber Emulsions

### EXAMPLE 1

A mixture of 80.0% by weight AC-20 petroleum asphalt and 20.0% by weight of minus mesh granulated recycled tire rubber was prepared by mixing the two components together at, and continuing to mix the two components at 400 degrees Fahrenheit for 90 minutes. While the petroleum asphalt tire rubber was mixing, a clay in water solution comprised of 46.38% by weight water and 53.62% by weight kaolinite clay was prepared. This mixture was prepared using a common kitchen cake mixer equipped with two beaters at slow speed in a half gallon metal can, using warm water at 90 to 100 degrees Fahrenheit. After the petroleum asphalt tire rubber mixture had been reacted for 90 minutes at 400 degrees Fahrenheit it was slowly added at temperatures of 325 to 400 degrees to the clay in water solution, mixed, and emulsified using the same kitchen cake mixer.

The clay in water solution readily emulsified the petroleum asphalt tire rubber, however as the emulsion being produced approached 210 degrees, additional water was slowly added to keep the temperature of the emulsion at between 160 and 210 degrees. After all of the required petroleum asphalt tire rubber mixture had been added, additional water was added to the emulsion to adjust the final viscosity to 9800 cps. The petroleum asphalt recycled tire rubber emulsion was also found to have a residue by evaporation of 52.1% by weight. This emulsion comprised 47.9% by weight water, 33.6% by weight petroleum asphalt recycled tire rubber mixture, and 18.5% by weight kaolinite clay. This emulsion was found to be suitable as a crackfiller for asphalt and portland cement pavements, as a sealcoat material after being combined with sand for asphalt pavements, and as a product that meets or exceeds the specifications for ASTM D 1227 Type II protective coating for roofing, and meets or exceeds the specifications for ASTM D 1187 Type I protective coating for metal surfaces.

### EXAMPLE 2

A mixture of 80.0% by weight AC-20 petroleum asphalt and 20.0% by weight of minus 20 mesh granulated recycled tire rubber was prepared by mixing the two components together at 400 degrees Fahrenheit and maintaining the temperature of the mixture at approximately 400 degrees Fahrenheit for 90 minutes. While the petroleum asphalt tire rubber was mixing, a clay in water solution comprising 46.0% warm water at 90 to 100 degrees Fahrenheit, 0.3% by weight sodium metasilicate pentahydrate, and 53.7% by weight kaolinite clay was prepared in a half gallon metal can using a kitchen cake mixer equipped with two beaters at slow speed. The petroleum asphalt tire rubber mixture was slowly added at temperatures of 325 to 400 degrees Fahrenheit to the clay in water solution, along with additional cold water to keep the emulsion that was being made at temperatures of 160 to 210 degrees Fahrenheit, until the required amount of petroleum asphalt tire rubber mixture had been added. To this mineral colloidal emulsion was then added water to adjust its viscosity and residue content along with vinyl acrylic latex and fiberglass fibers.

The final emulsion produced comprised 45.0% by weight water, 17.5% by weight kaolinite clay, 0.1% by weight sodium metasilicate pentahydrate, 32% by weight petroleum asphalt tire rubber mixture, 5.0% by Union Carbide UCAR 503 Vinyl Acrylic Latex, and 0.4% by weight Fiber Pave 6010 fiberglass fibers. The residue of the emulsion was found to be 55.0% by weight. This petroleum asphalt tire rubber emulsion was found to be a dimensionally stable cold applied crackfiller for asphalt and portland cement pavements, and as an ASTM D 1227 Type IV protective coating for roofing, and as an ASTM D 1187 Type I protective coating for metal surfaces.

### EXAMPLE 3

A mixture of 79.70% by weight AC-5 petroleum asphalt, 5.20% by weight clear saturated petroleum oil, 5.60% by weight tall oil pitch, 0.60% by weight caustic soda, 2.60% by weight styrene butadiene copolymer, 6.20% by weight granulated and recycled 80 mesh tire rubber, and 0.10% by weight sulfur was prepared at temperatures of 350 to 380 degrees Fahrenheit, using a high shear mixer at 6000 rpm, and then stored overnight at 350 degrees Fahrenheit. When tested, this mixture was found to comply with specifications for Performance Grade(PG) 70-40 recycled tire rubber modified petroleum asphalt. A solution at 100 degrees Fahrenheit comprised of 93.15% by weight water, 6.05% by weight bentonite clay, and 0.80% by weight sodium dichromate was prepared. To this solution, was introduced slowly, the PG Grade 70-40 recycled tire rubber modified petroleum asphalt at a temperature of 350 degrees Fahrenheit, with a mixer equipped with a Silverson Duplex mixer-dissolver workhead turning at 6000 to 8000 rpm.

During the addition of the hot tire rubber modified petroleum asphalt, 1.0% by weight of a nonylphenol surfactant with 40 moles of ethylene oxide was added to reduce the viscosity of the resulting emulsion to acceptable levels. A thick brown emulsion was formed comprised of 46.2% by weight water, 0.4% by.weight sodium dichromate, 3.0% by weight bentonite clay, 49 .4% by weight PG 70-40 recycled tire rubber modified petroleum asphalt, and 1.0% nonylphenol surfactant. The residue of this emulsion was tested and found to be 53.8% by weight. This emulsion was found to be satisfactory as a slurry seal protective coating for petroleum asphalt pavements when mixed in the proportions of 50 to 65% by weight of slurry seal mineral aggregate moistened with 0 to 8% by weight water, and to which is added 24 to 40% by weight of the recycled tire rubber modified emulsion; mixed and then spread out onto the surface of the asphalt pavement. This improved recycled tire rubber modified emulsion was also found to comply with specifications for ASTM D 1227 Type III Roof Coating.

### EXAMPLE 4

A recycled tire rubber modified petroleum asphalt was prepared by mixing 62.50% by weight Performance Grade (PG) 64-22 petroleum asphalt with 10.00% by weight of minus 30 mesh granulated recycled tire rubber at a temperature of 500 degrees Fahrenheit for 15 minutes, and then adding 11.50% by weight tall oil pitch, 7.00% gilsonite, and 9.00% of reclaimed and recycled motor oil flux. The recycled tire rubber modified petroleum asphalt was then allowed to cool to between 325 to 375 degrees Fahrenheit. While the recycled tire rubber modified petroleum asphalt was cooling a solution comprised of 92.10% by weight water, 0.47% by weight sodium chromate, 3.48% by weight nonylphenol surfactant, and 3.95% by weight of bentonite clay was prepared at 85 degrees Fahrenheit. To the clay in water solution was slowly added the recycled tire rubber modified petroleum asphalt at temperatures of 325 to 375 degrees Fahrenheit with mixing provided by a Silverson Duplex mixer-dissolver operating at 6000 to 9000 rpm.

The resulting emulsion that was formed was mixed for another 30 minutes with the ultra high shear mixer-dissolver work head. When completed, the emulsion had a temperature of 190 degrees Fahrenheit. An additional 2.25% by weight minus 30 mesh granulated recycled tire rubber along with 2.05% by weight cationic styrene butadiene latex rubber was added and blended in and then the emulsion was allowed to cool to 75 degrees Fahrenheit. The residue of this emulsion was found to be 50.52% by weight. The viscosity of the emulsion when tested with a Brookfield Viscosimeter with a #6 spindle at 10 rpm was found to be 3800 centipoise. The composition of this emulsion is 49.00% by weight water, 0.25% by weight sodium chromate, 1.85% by weight nonylphenol surfactant, 2.10% by weight bentonite clay, 42.50% by weight recycled tire rubber modified petroleum asphalt, 2.25% by weight additional minus 30 mesh tire granulated recycled tire rubber, and 2.05% by weight cationic rubber latex.

This improved recycled tire rubber modified emulsion was found to be satisfactory in the preparation of slurry seal asphalt pavement coatings. To prepare such coatings 50 to 65% by weight of slurry seal mineral aggregate is moistened with 0 to 8% by weight water, and 24 to 40% by weight of the improved tire rubber modified emulsion is added, mixed and then spread out onto the surface of an asphalt pavement and allowed to cure. The improved recycled tire rubber modified emulsion was also found to comply with specifications for ASTM D 1227 Type III Roof Coating.

### EXAMPLE 5

A petroleum asphalt meeting the specifications for Performance Grade (PG) 64-22 was heated to 325 degrees Fahrenheit. A solution comprised of 94.05% by weight water, 0.45% by weight chromic acid, and 5.5% by weight bentonite clay was prepared at 90 degrees Fahrenheit. The petroleum asphalt at temperatures of 275 to 325 degrees Fahrenheit was slowly added to the bentonite, chromic acid, water solution as it was being agitated at 6000 to 7500 rpm using an ultra high shear mixer until the required amount of petroleum asphalt had been added. The resulting emulsion was then agitated for another 20 minutes using the ultra high shear mixer. With the emulsion now at 180 degrees Fahrenheit, 10.0% by weight of minus 30 mesh granulated recycled tire rubber was added and blended in using the ultra high shear mixer. Then, 4.0% by weight of Union Carbide UCAR 503 Vinyl Acrylic Latex was added using the ultra high shear mixer.

The final emulsion had a temperature of 162 degrees Fahrenheit, a residue by evaporation of 55.8% by weight, and a viscosity of 4850 centipoise. This improved tire rubber modified emulsion was found to be satisfactory in the preparation of slurry seal asphalt pavement coatings. To prepare such coatings 50 to 65% by weight of slurry seal mineral aggregate is moistened with 0 to 8% water and 24 to 49% by weight of the improved tire rubber modified emulsion is added, mixed and then spread out evenly on the surface of an asphalt pavement and allowed to cure. The improved recycled tire rubber modified emulsion was also found to comply with specifications for ASTM D 1227 Type III Roof Coatings.

B. Processes for Making the Improved Petroleum Asphalt Tire Rubber Emulsions

In examples 1 and 2 the improved petroleum asphalt tire rubber modified emulsions are made with low to moderate agitation and shear. The preferred equipment for production is a cylindrical, or semi-cylindrical horizontal tank equipped with a central shaft with paddles, and or helical ribbons. These tanks are commonly referred to as paddle mixers and ribbon blenders. There are vertical cylindrical tanks that may also be used that are equipped vertically suspended paddles, turbines, or helical ribbons, or combinations of these, and that may have more than one vertically suspended shafts.

The first step to make emulsions disclosed in examples 1 and 2 is to prepare a clay slurry comprised of 50 to 55% by weight kaolinite clay in 50 to 45% by weight water. Other chemicals such as sodium metasilicates, sodium chromate, sodium dichromate, potassium dichromate, chromic acid, citric acid, hydrochloric acid, acetic acid, ferric chloride or aluminum chloride may also be added at this step. This clay slurry may be made at temperatures of 40 to 120 degrees Fahrenheit, and must be stirred until the clay is well dispersed and lump free.

Based upon 30 to 40% by weight of the final emulsion to be made, the tire rubber modified petroleum asphalt, at temperatures of 400 to 325 degrees Fahrenheit, is then added slowly to the clay slurry while the agitator, or agitators are turning. Mixing continues until the required amount of tire rubber modified petroleum asphalt has been added, and further continues until the tire rubber modified petroleum asphalt emulsion has been formed. During the addition of the tire rubber modified petroleum asphalt additional water at 40 to 100 degrees Fahrenheit is added to prevent the mixture from boiling, and to keep the viscosity low enough for the agitators to be effective. After all the required amount of recycled tire rubber modified petroleum asphalt has been added, the emulsion is mixed for a period of 15 to 60 minutes to completely emulsify the recycled tire rubber modified petroleum asphalt.

Additional water may then be added to adjust the viscosity to between 2500 to 20,000 centipoise, and 48 to 55% by weight residue. The final emulsion obtained typically has a temperature of between 130 to 210 degrees Fahrenheit.

Moderate to high shear mixers such as batch type vertical, bottom entry, or side entry mixers may also be used to produce the emulsions in examples 1 and 2. With these types of mixers, the initial kaolinite clay slurry is usually 15 to 29% by weight clay. Chemicals such as sodium metasilicates, sodium silicates, acetic acid, hydrochloric acid, citric acid, chromic acid, and sodium or potassium chromate salts are then added to adjust the pH of the clay water slurry and impart desired end product viscosity. The required quantity of tire rubber modified petroleum asphalt is then slowly added while the agitators are turning at 2500 to 8000 rpm. Mixing continues until the recycled tire rubber modified petroleum asphalt has been completely emulsified. Near the end of the mixing process, additional water and latex additives may be added to adjust the viscosity and residue contents of the emulsion. Temperatures of the final emulsions are typically 130 to 210 degrees Fahrenheit with these processes.

Continuous high shear mixers, commonly known as colloid mills may also be used to prepare the emulsions in examples 1 and 2, particularly when there is the capability to recirculate the entire batch of emulsion being made through the colloid mill until the recycled tire rubber modified petroleum asphalt has been completely emulsified and adjusted to its desired residue content and viscosity.

In examples 3 and 4 the tire rubber modified petroleum asphalt emulsions are made with an ultra high shear mixer equipped with a high speed chopper within a shrouded zone above a rotor-stator workhead. As the ultra high shear mixer turns a high speed, a strong vortex is generated which draws the recycled tire rubber modified petroleum asphalt into the shrouded zone where it is chopped into small enough pieces to be emulsified by the rotor-stator workhead. There are two manufacturers of these types of ultra high shear mixers. Charles Ross and Son Company makes a mixer known as the Ross Mixer Dissolver. The other is made by Silverson Machines, Inc., and is known as the Duplex Disintegrator/Dissolver.

Continuous high shear colloid mills equipped with multiple inline rotor stators such as the Greerco Corp. Tandem Shear Pipeline Mixer, The Greerco Corp Tandem Refiner, and the Ika Works, Inc. Dispax-Reactor may also be used to produce the emulsions in examples 3 and 4.

The emulsion in example 5 may be made with single ultra high shear batch mixers, ultra high shear mixers equipped with choppers in a shrouded zone, with single stage colloid mills, and with colloid mills equipped with multiple inline rotor stators. The granulated recycled tire rubber and other modifiers may be added immediately after the bentonite clay emulsion has been made at elevated temperatures of 130 to 210 degrees Fahrenheit.

1. A method of preparing an asphalt recycled tire rubber emulsion which may be used as a crack-filler for asphalt and portland cement pavements, as a roof coating, slurry seal coating, or as a seal coat for asphalt pavements, the method comprising:
preparing a first mixture of a asphalt-recycled tire rubber base by mixing together a first weight percent AC-20 petroleum asphalt and a second weight percent of granulated recycled tire rubber by mixing the two components together at, and continuing to mix the two components at 400 degrees Fahrenheit for 90 minutes;
preparing a second mixture comprising a third weight percent water and a fourth weight percent clay, using warm water at 90 to 100 degrees Fahrenheit; and
adding the first mixture, at temperatures of 325 to 400 degrees to the clay in water solution to form an emulsion, slowly adding additional water as necessary to keep the temperature of the emulsion at between 160 and 210 degrees.

2. The method of claim 1 wherein, after all of the first mixture has been added to the second mixture, adding additional water to adjust the final viscosity to a range of 2500 to 20,000 centipoise.

3. The method of claim 1 wherein the first weight percent is 80.0% and the second weight percent is 20%.

4. The method of claim 1 wherein the third weight percent is 46.38% and the fourth weight percent is 53.62%.

5. The method of claim 1 wherein the clay comprises kaolinite.

6. The method of claim 1 wherein the clay comprises bentonite.

7. The method of claim 1 wherein the clay comprises magnesium silicate.

8. The method of claim 1 wherein the clay comprises a blend of kaolinite, bentonite and magnesium silicate.

9. The method of claim 1 wherein the first mixture further comprises a performance enhancing additive.

10. The method of claim 9 wherein the performance enhancing additive is selected from the group consisting of petroleum asphalt, petroleum base oils, reclaimed and recycled motor oils and fluxes, styrene butadiene—styrene coblock polymers, styrene isoprene—styrene coblock polymers, ethylene vinyl acetate polymers, polymer latex, manmade fiber and natural fiber.

11. The method of claim 9 wherein the performance enhancing additive is selected from any one or more of the group comprising petroleum asphalt, petroleum base oils, reclaimed and recycled motor oils and fluxes, styrene butadiene—styrene coblock polymers, styrene isoprene—styrene coblock polymers, ethylene vinyl acetate polymers, polymer latex, manmade fiber, and natural fiber.

12. The method of claim 1 wherein the second mixture further comprises a pH adjusting substance.

13. The method of claim 12 wherein the pH adjusting substance is selected from the group consisting of hydrochloric acid, citric acid, acetic acid, chromic acid, sodium chromate, sodium dichromate, potassium dichromate, aluminum chloride, ferric chloride, sodium hydroxide, sodium metasilicate pentahydrate, and sodium metasilicate nanohydrate.

14. The method of claim 12 wherein the pH adjusting substance is selected from any one or more of the group comprising hydrochloric acid, citric acid, acetic acid, chromic acid, sodium chromate, sodium dichromate, potassium dichromate, aluminum chloride, ferric chloride, sodium hydroxide, sodium metasilicate pentahydrate, and sodium metasilicate nanohydrate.

15. The method of claim 1 wherein the second mixture comprises a co-emulsifier.

16. The method of claim 15 wherein the co-emulsifier comprises a nonylphenol surfactant.

17. The method of claim 15 wherein the co-emulsifier comprises quaternary ammonium chloride.

18. The method of claim 15 wherein the co-emulsifier comprises ferric chloride.

19. The method of claim 1 wherein the emulsion further comprises an end use modifying additive.

20. The method of claim 19 wherein the end use modifying additive is selected from the group consisting of crushed and sieve sized mineral aggregates, crushed and sieve sized recycled asphalt pavement, crushed and sieve sized portland cement concrete, and sand.

21. The method of claim 19 wherein the end use modifying additive is selected from any one or more of the group comprising crushed and sieve sized mineral aggregates, crushed and sieve sized recycled asphalt pavement, crushed and sieve sized portland cement concrete, and sand.

22. The method of claim 1 wherein the granulated recycled tire rubber is minus 16 mesh to minus 80 mesh.

23. An asphalt emulsion produced according to the method of claim 1.

24. A method of preparing an asphalt recycled tire rubber emulsion which may be used as a crack-filler for asphalt and portland cement pavements, as a roof coating, slurry seal coating, or as a seal coat for asphalt pavements, the method comprising:
preparing a first mixture of an asphalt-recycled tire rubber base by mixing together a first weight percent AC-20 petroleum asphalt and a second weight percent of granulated recycled tire rubber by mixing the two components together at, and continuing to mix the two components at 400 degrees Fahrenheit for 90 minutes;
preparing a second mixture comprising a third weight percent water, a fourth weight percent clay, and a fifth weight percent sodium metasilicate pentahydrate, using warm water at 90 to 100 degrees Fahrenheit; and
adding the first mixture, at temperatures of 325 to 400 degrees, to the clay in water solution to form an emulsion, slowly adding additional cold water as necessary to keep the temperature of the emulsion at between 160 and 210 degrees.

25. The method of claim 24 wherein, after all of the first mixture has been added to the second mixture, adding a third mixture comprising water, vinyl acrylic latex and fiberglass fibers.

26. The method of claim 24 wherein the first weight percent is 80.0% and the second weight percent is 20%.

27. The method of claim 24 wherein the third weight percent is 46.0%, the fourth weight percent is 53.7% and the fifth weight percent is 0.3%.

28. The method of claim 24 wherein the clay comprises kaolinite.

29. The method of claim 24 wherein the clay comprises bentonite.

30. The method of claim 24 wherein the clay comprises magnesium silicate.

31. The method of claim 24 wherein the clay comprises a blend of kaolinite, bentonite and magnesium silicate.

32. The method of claim 24 wherein the first mixture further comprises a performance enhancing additive.

33. The method of claim 32 wherein the performance enhancing additive is selected from the group consisting of petroleum asphalt, petroleum base oils, reclaimed and recycled motor oils and fluxes, styrene butadiene—styrene coblock polymers, styrene isoprene—styrene coblock polymers, ethylene vinyl acetate polymers, polymer latex, manmade fiber and natural fiber.

34. The method of claim 32 wherein the performance enhancing additive is selected from any one or more of the group comprising petroleum asphalt, petroleum base oils, reclaimed and recycled motor oils and fluxes, styrene butadiene—styrene coblock polymers, styrene isoprene—styrene coblock polymers, ethylene vinyl acetate polymers, polymer latex, manmade fiber, and natural fiber.

35. The method of claim 24 wherein the second mixture further comprises a pH adjusting substance.

36. The method of claim 35 wherein the pH adjusting substance is selected from the group consisting of hydrochloric acid, citric acid, acetic acid, chromic acid, sodium chromate, sodium dichromate, potassium dichromate, aluminum chloride, ferric chloride, sodium hydroxide, sodium metasilicate pentahydrate, and sodium metasilicate nanohydrate.

37. The method of claim 35 wherein the pH adjusting substance is selected from any one or more of the group comprising hydrochloric acid, citric acid, acetic acid, chromic acid, sodium chromate, sodium dichromate, potassium dichromate, aluminum chloride, ferric chloride, sodium hydroxide, sodium metasilicate pentahydrate, and sodium metasilicate nanohydrate.

38. The method of claim 24 wherein the second mixture comprises a co-emulsifier.

39. The method of claim 38 wherein the co-emulsifier comprises a nonylphenol surfactant.

40. The method of claim 38 wherein the co-emulsifier comprises quaternary ammonium chloride.

41. The method of claim 38 wherein the co-emulsifier comprises ferric chloride.

42. The method of claim 24 wherein the emulsion further comprises an end use modifying additive.

43. The method of claim 42 wherein the end use modifying additive is selected from the group consisting of crushed and sieve sized mineral aggregates, crushed and sieve sized recycled asphalt pavement, crushed and sieve sized portland cement concrete, and sand.

44. The method of claim 42 wherein the end use modifying additive is selected from any one or more of the group comprising crushed and sieve sized mineral aggregates, crushed and sieve sized recycled asphalt pavement, crushed and sieve sized portland cement concrete, and sand.

45. The method of claim 24 wherein the granulated recycled tire rubber is minus 16 mesh to minus 80 mesh.

46. An asphalt emulsion produced according to the method of claim 24.

47. A method of preparing an asphalt recycled tire rubber emulsion which may be used as a crack-filler for asphalt and portland cement pavements, as a roof coating, slurry seal coating, or as a seal coat for asphalt pavements, the method comprising:
preparing a first mixture of a asphalt-recycled tire rubber base by mixing together 79.70 weight percent AC-5 petroleum asphalt, 5.20 weight percent clear saturated petroleum oil, 0.60 by weight percent caustic soda, 2.60 by weight percent styrene butadiene copolymer, 6.20 by weight percent granulated recycled tire rubber, and 0.10 by weight percent sulfur by mixing the components together at 350 to 380 degrees Fahrenheit;
maintaining the temperature of the first mixture at approximately 350 degrees Fahrenheit for a period of at least 8 hours;
preparing a second mixture at approximately 100 degrees Fahrenheit, the second mixture comprising 93.15 weight percent water, 6.05 weight percent clay, and 0.80 weight percent sodium dichromate; and
adding, slowly, the first mixture, at a temperature of approximately 350 degrees Fahrenheit, to the second mixture, and mixing the two mixtures together.

48. The method of claim 47 wherein the granulated recycled tire rubber comprises a range of minus 16 to minus 80 mesh.

49. The method of claim 47 wherein the clay comprises kaolinite.

50. The method of claim 47 wherein the clay comprises bentonite.

51. The method of claim 47 wherein the clay comprises magnesium silicate.

52. The method of claim 47 wherein the components of the first mixture are mixed together with a high shear mixer at 6000 rpm.

53. The method of claim 47 wherein the first mixture and second mixture are mixed together at 6000 to 8000 rpm.

54. The method of claim 47 wherein a third mixture comprising 1.0 weight percent nonylphenol surfactant and 40 moles ethylene oxide is added as the first mixture and second mixture are mixed together.

55. An asphalt emulsion produced according to the method of claim 47.

56. A method of preparing an asphalt recycled tire rubber emulsion which may be used as a crack-filler for asphalt and portland cement pavements, as a roof coating, slurry seal coating, or as a seal coat for asphalt pavements, the method comprising:
preparing a first mixture of a asphalt-recycled tire rubber base by mixing together 62.50 weight percent Performance Grade 64-22 petroleum asphalt and 10.00 weight percent granulated recycled tire rubber;
blending the first mixture at a temperature of 500 degrees Fahrenheit for 15 minutes;
adding to the first mixture, 11.50 weight percent tall oil pitch, 7.00 weight percent gilsonite, and 9.00 weight percent reclaimed and recycled motor oil flux to form a modified first mixture;
allowing the modified first mixture to cool to between 325 to 375 degrees Fahrenheit;
preparing a second mixture comprising 92.10 weight percent water, 0.47 weight percent sodium chromate, 3.48 weight percent nonylphenol surfactant, and 3.95 weight percent clay at a temperature of approximately 85 degrees Fahrenheit;
blending slowing the modified first mixture, at temperatures of 325 to 375 degrees Fahrenheit, to the second mixture to create an emulsion, mixing the emulsion for thirty minutes; and
adding a third mixture to the emulsion, the third mixture comprising an additional 2.25 by weight percent granulated recycled tire rubber and 2.05 by weight percent cationic styrene butadiene latex rubber, allowing the combination of the emulsion and the third mixture to cool to 75 degrees Fahrenheit.

57. The method of claim 56 wherein the granulated recycled tire rubber comprises a range of minus 16 to minus 80 mesh.

58. The method of claim 56 wherein the clay comprises kaolinite.

59. The method of claim 56 wherein the clay comprises bentonite.

60. The method of claim 56 wherein the clay comprises magnesium silicate.

61. The method of claim 56 wherein the modified first mixture and second mixture are mixed together at 6000 to 9000 rpm.

62. An asphalt emulsion produced according to the method of claim 56.

63. A method of preparing an asphalt recycled tire rubber emulsion which may be used as a crack-filler for asphalt and portland cement pavements, as a roof coating, slurry seal coating, or as a seal coat for asphalt pavements, the method comprising:
heating 62.50 weight percent Performance Grade 64-22 petroleum asphalt to 325 degrees Fahrenheit;
preparing a second mixture comprising 94.05 weight percent water, 0.45 weight percent chromic acid, and 5.50 weight percent clay at a temperature of approximately 90 degrees Fahrenheit;
blending the Performance Grade 64-22 petroleum asphalt, heated to 275 to 325 degrees Fahrenheit, to the second mixture to create an emulsion and mixing the emulsion for twenty minutes;
adding 10.00 by weight percent granulated recycled tire rubber to the emulsion; and
adding 4.0 by weight percent vinyl acrylic latex to the emulsion.

64. The method of claim 63 wherein the granulated recycled tire rubber comprises a range of minus 16 to minus 80 mesh.

65. The method of claim 63 wherein the clay comprises kaolinite.

66. The method of claim 63 wherein the clay comprises bentonite.

67. The method of claim 63 wherein the clay comprises magnesium silicate.

68. The method of claim 63 wherein the Performance Grade 64-22 petroleum asphalt and second mixture are mixed together at 6000 to 7500 rpm.

69. An asphalt emulsion produced according to the method of claim 63.

70. A composition of an asphalt-recycled tire rubber emulsion which may be used as a crack-filler for asphalt and portland cement pavements, as a roof coating, slurry seal coating, or as a seal coat for asphalt pavements, the composition comprising:
a first mixture of a petroleum asphalt-recycled tire rubber base comprising 80.0 percent by weight AC-20 petroleum asphalt and 20% by weight minus 20 mesh granulated recycled tire rubber, the first mixture blended with a second mixture, the second mixture comprising 46.38 percent by weight water and 53.62 percent by weight clay, wherein the blended first mixture and second mixture results in an emulsion comprising 47.9 percent by weight water, 33.6 percent by weight asphalt-tire rubber and 18.5 percent by weight clay.

71. A composition of an asphalt-recycled tire rubber emulsion which may be used as a crack-filler for asphalt and portland cement pavements, as a roof coating, slurry seal coating, or as a seal coat for asphalt pavements, the composition comprising:
a first mixture of a petroleum asphalt-recycled tire rubber base comprising 80.0 percent by weight AC-20 petroleum asphalt and 20 percent by weight minus 20 mesh granulated recycled tire rubber, the first mixture blended with a second mixture, the second mixture comprising 46.0 percent by weight water, 53.7 percent by weight kaolinite clay, and 0.3 percent by weight sodium metasilicate pentahydrate, vinyl acrylic latex and fiberglass fibers, wherein the blended first mixture and second mixture results in an emulsion comprising 45.0 percent by weight water, 32 percent by weight asphalt-tire rubber, 17.5 percent by weight kaolinite clay, 0.1 percent by weight sodium metasilicate pentahydrate, 5.0 percent by weight vinyl acrylic latex and 0.4% fiberglass fibers.

72. A composition of an asphalt-recycled tire rubber emulsion which may be used as a crack-filler for asphalt and portland cement pavements, as a roof coating, slurry seal coating, or as a seal coat for asphalt pavements, the composition comprising:
a first mixture of a petroleum asphalt-recycled tire rubber base comprising 79.70 percent by weight AC-5 petroleum asphalt, 5.20 percent by weight tall oil pitch, 0.60 percent by weight caustic soda, 2.60 percent by weight styrene butadiene copolymer, 6.20 percent by weight 80 mesh granulated recycled tire rubber, and 0.10 percent by weight sulfur, the first mixture blended with a second mixture and a third mixture, the second mixture comprising 93.15 percent by weight water, 6.05 percent by weight bentonite clay, and 0.80 percent by weight sodium dichromate, and the third mixture comprising 1.0 percent by weight nonylphenol surfactant with 40 moles of ethylene oxide wherein the blended first mixture, second mixture and third mixture results in an emulsion comprising 46.20 percent by weight water, 49.4 percent by weight asphalt-tire rubber, 3.0 percent by weight bentonite clay, 0.4 percent by weight sodium dichromate, and 1.0 percent by weight nonylphenol surfactant.

73. A composition of an asphalt-recycled tire rubber emulsion which may be used as a crack-filler for asphalt and portland cement pavements, as a roof coating, slurry seal coating, or as a seal, coat for asphalt pavements, the composition comprising:
a first mixture of a petroleum asphalt-recycled tire rubber base comprising 62.50 percent by weight Performance Grade 64-22 petroleum asphalt, 10.00 percent by weight minus 30 mesh granulated recycled tire rubber, 11.50 percent by weight tall oil pitch, 7.00 percent by weight gilsonite, and 9.00 percent by weight reclaimed and recycled motor oil flux, the first mixture blended with a second mixture and a third mixture, the second mixture comprising 92.10 percent by weight water, 0.47 percent by weight sodium chromate, 3.48 percent by weight nonylphenol surfactant, and 3.95 percent by weight bentonite clay, and the third mixture comprising 2.25 percent by weight minus 30 mesh granulated recycled tire rubber and 2.05 percent by weight cationic styrene butadiene latex rubber, wherein the blended first mixture, second mixture and third mixture results in an emulsion comprising 49.0 percent by weight water, 42.50 percent by weight asphalt-tire rubber, 2.10 percent by weight bentonite, 2.25 percent by weight additional minus 30 mesh granulated recycled tire rubber, 0.25 percent by weight sodium dichromate, 1.85 percent by weight nonylphenol surfactant, and 2.05 percent by weight cationic rubber latex.

74. A composition of an asphalt-recycled tire rubber emulsion which may be used as a crack-filler for asphalt and portland cement pavements, as a roof coating, slurry seal coating, or as a seal coat for asphalt pavements, the composition comprising:
petroleum asphalt meeting the specifications for Performance Grade 64-22 petroleum asphalt, the petroleum asphalt blended with a second mixture and a third mixture, the second mixture comprising 94.05 percent by weight water, 0.45 percent by weight chromic acid, and 5.5 percent by weight bentonite clay, and the third mixture comprising 10.0 percent by weight minus 30 mesh granulated recycled tire rubber, and 4.0 percent by weight vinyl acrylic latex, wherein the blended petroleum asphalt, second mixture and third mixture results in an emulsion.
